(19) United States
(12) Patent Application Publication
(10) Pub. No.: US 2018/0062361 A1
(43) Pub. Date: Mar. 1, 2018

(54) DOUBLE V STRINGING BLOCK

(71) Applicant: MacLean Power, L.L.C., Fort Mill, SC (US)

(72) Inventors: Maxwell Goldsmith, Birmingham, AL (US); Wei-Chung Lin, Birmingham, AL (US)

(73) Assignee: MacLean Power, L.L.C., Fort Mill, SC (US)

(21) Appl. No.: 15/689,094

(22) Filed: Aug. 29, 2017

Related U.S. Application Data
(60) Provisional application No. 62/381,552, filed on Aug. 30, 2016.

(51) Int. Cl. H02G 1/02

(52) U.S. Cl. CPC H02G 1/02

(57) ABSTRACT

The present disclosure provides a stringing block. The stringing block may include a sheave with a circumferential groove with a pair of opposed walls. The opposed walls may extend away from the base of the groove to a flair point at a first angle. The opposed walls may extend away from the flair point to a rim at a second angle that is less than the first angle.

### RELATED APPLICATIONS

The present patent document claims the benefit of the filing date under 35 U.S.C. § 119(e) of Provisional U.S. Patent Application Ser. No. 62/381,552, filed Aug. 30, 2016, which is hereby incorporated by reference.

### BACKGROUND

Stringing blocks are used by lineman from utility companies in many aspects of their jobs, such as for holding transmission lines, wires, cables, etc. (collectively “conductors”) as the conductors are pulled/strung between locations, such as electrical towers or poles. Stringing block assemblies include rotatable sheaves held in a frame. The sheaves within stringing block assemblies may be referred to as wheels or blocks themselves. The conductors held by the stringing blocks vary in size. The conductors can be damaged due to excessive vibration within the stringing block or impact with the stringing block as the conductors are pulled through the stringing block. One disadvantage of currently-known stringing blocks is the inability to use a single stringing block with multiple sized conductors.

### SUMMARY

In one aspect, the present disclosure provides a sheave. The sheave comprises a circumferential groove. The circumferential groove includes a pair of opposed wall surfaces that converge at a base surface, where each of the opposed wall surfaces extends outwardly from the base surface to a flair point at an angle of approximately 45 degrees with respect to a vertical line bisecting the center of the base surface, and where each of the opposed wall surfaces extends outwardly from the flair point at an angle of approximately 16 degrees with respect to the vertical line to a rim.

In a second aspect, the present disclosure provides a sheave comprising a groove extending along an outer circumference of the sheave. The groove includes a first wall surface and an opposing second wall surface. The first wall surface has a first bottom portion and a first top portion converging at a first transition point and the second wall surface has a second bottom portion and a second top portion converging at a second transition point. The first bottom portion is oriented at an angle of approximately 90 degrees with respect to the second bottom portion, and the first top portion is oriented at an angle of approximately 32 degrees with respect to the second top portion.

In a third aspect, the present disclosure provides a stringing block assembly comprising a frame and a sheave rotatably mounted in the frame. The sheave comprises a circumferential groove. The circumferential groove includes a pair of opposed wall surfaces that converge at a base surface, where each of the opposed wall surfaces extends outwardly from the base surface to a flair point at an angle of approximately 45 degrees with respect to a vertical line bisecting the center of the base surface, and where each of the opposed wall surfaces extends outwardly from the flair point at an angle of approximately 16 degrees with respect to the vertical line to a rim.

### BRIEF DESCRIPTION OF THE DRAWINGS

The invention can be better understood with reference to the following drawings and description. The components in the figures are not necessarily to scale, emphasis instead being placed upon illustrating the principles of the invention. Any dimensions shown in the figures are in inches and are exemplary. Moreover, in the figures, like referenced numerals designate corresponding parts throughout the different views.

FIG. 1 is a perspective view of a double V stringing block embodiment.

FIG. 2A is an elevation view of the double V stringing block embodiment.

FIG. 2B is a cross-sectional side view of the double V stringing block embodiment.

FIG. 3 is a partial cross-sectional view of the double V stringing block embodiment.

FIG. 4A is a graph of the position of the center of gravity of a conductor in the double V stringing block embodiment.

FIG. 4B is partial cross-sectional views of double V stringing block embodiments.

FIG. 5A is a graph of the position of the center of gravity of a conductor in the double V stringing block embodiment.

FIG. 5B is partial cross-sectional views of double V stringing block embodiments.

FIG. 6A is a graph of the position of the center of gravity of several conductors in the double V stringing block embodiment.

FIG. 6B is a graph of the displacement of the centroids of several conductors in the double V stringing block embodiment.

FIG. 7 is a graph of the position of the center of gravity of a Linnet conductor in the double V stringing block embodiment.

FIG. 8 is a graph of the position of the center of gravity of a Hawk conductor in the double V stringing block embodiment.

FIG. 9 is a graph of the position of the center of gravity of a Dove conductor in the double V stringing block embodiment.

FIG. 10 is a graph of the position of the center of gravity of a Drake conductor in the double V stringing block embodiment.

FIG. 11 is a graph of the position of the center of gravity of a Rail conductor in the double V stringing block embodiment.

### DETAILED DESCRIPTION

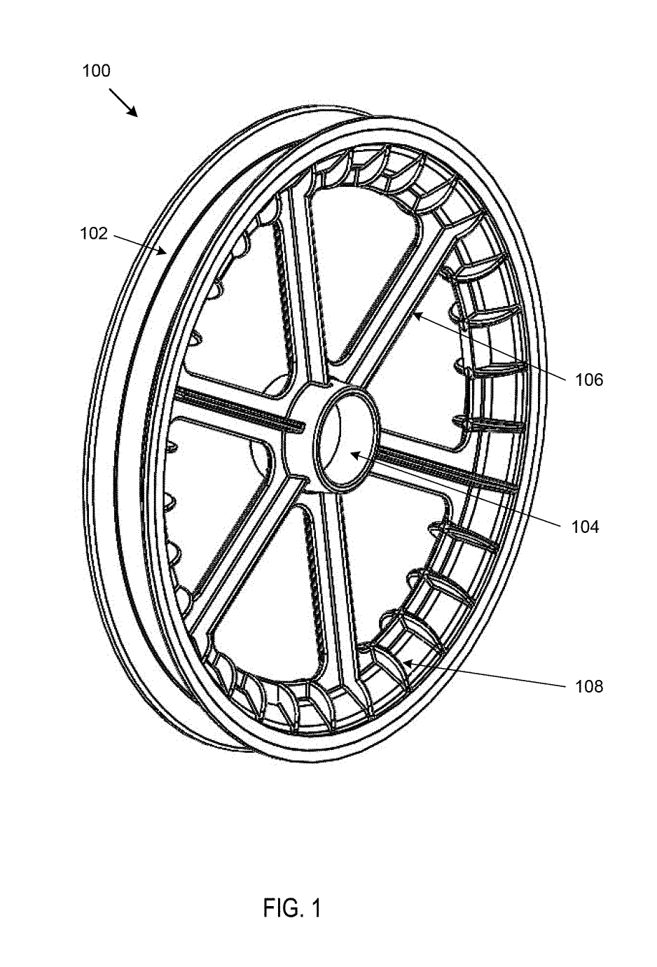

FIG. 1 shows a perspective view of a double V stringing block 100. Double V stringing block 100 may include a groove 102, a central hub 104, and a groove support member 106. The groove support member 106 may be a plurality of spokes, as shown in FIG. 1, connecting the groove 102 to the hub 104. The double V stringing block 100 may include a plurality of ribs 108 spaced throughout the double V stringing block 100 to stiffen and strengthen the double V stringing block 100.

In some configurations, the double V stringing block 100 may be circular in shape, as shown in FIG. 1. In other configurations, the double V stringing block 100 could be configured with a round, annular, ring-like, disk-like, discoid, or other closed curve shape.

FIG. 1 shows the groove 102 as a circumferential groove on the double V stringing block 100. In some configurations, the groove 102 of the double V stringing block 100 may be integrally formed in the double V stringing block 100. The groove 102 may also be formed or molded from other material, such as urethane material, adhered to, fixed, or otherwise mounted to the double V stringing block 100.

The double V stringing block 100 allows for multiple sized conductors, having diameters ranging from about 0.72 inches to about 1.165 inches, to be used with a single stringing block. Non-limiting examples of conductors that may be used in connection with the double V stringing block 100 are listed in Table 1.

TABLE 1

| | | | | | | | | | | | | | Resistance | | |
|---|---|---|---|---|---|---|---|---|---|---|---|---|---|---|---|
| | Size | | Diameter (ins.) | | | | | | | | | | OHMS/1000 | | |
| | (AWG | | Individual | | | | Weight Per | | | Content | | Rated | ft. | | Allowable |
| Code | or | Stranding | Wires | | Steel | Complete | 1000 ft (lbs.) | | | (%) | | Strength | DC@ | AC @ | Ampacity + |
| Word | Kcmil) | (Al/Stl) | Al | Stl | Core | Cable | Al | Stl | Total | Al | Stl | (lbs.) | 20° C. | 75° C. | (Amps) |
| Linnet | 336.4 | 26/7 | .1137 | .0885 | .2654 | .72 | 317 | 146 | 462 | 68.51 | 31.49 | 14100 | .0505 | .0618 | 529 |
| Oriole | 336.4 | 30/7 | .1059 | .1059 | .3177 | .741 | 318 | 209 | 526 | 60.35 | 39.65 | 17300 | .0502 | .0613 | 535 |
| Chickadee | 397.5 | 18/1 | .1486 | .1486 | .1486 | .743 | 373 | 58 | 431 | 86.43 | 13.57 | 9940 | .0432 | .0529 | 576 |
| Brant | 397.5 | 24/7 | .1287 | .0858 | .2574 | .772 | 374 | 137 | 511 | 73.21 | 26.79 | 14600 | .0430 | .0526 | 584 |
| Ibis | 397.5 | 26/7 | .1236 | .0962 | .2885 | .783 | 374 | 172 | 546 | 68.51 | 31.49 | 16300 | .0428 | .0523 | 587 |
| Lark | 397.5 | 30/7 | .1151 | .1151 | .3453 | .806 | 375 | 247 | 622 | 60.35 | 39.65 | 20300 | .0425 | .0519 | 594 |
| Pelican | 477 | 18/1 | .1628 | .1628 | .1628 | .814 | 447 | 70 | 517 | 86.44 | 13.56 | 11800 | .0360 | .0442 | 646 |
| Flicker | 477 | 24/7 | .141 | .094 | .2819 | .846 | 449 | 164 | 614 | 73.21 | 26.79 | 17200 | .0358 | .0439 | 655 |
| Hawk | 477 | 26/7 | .1354 | .1053 | .316 | .858 | 449 | 207 | 656 | 68.51 | 31.49 | 19500 | .0356 | .0436 | 659 |
| Hen | 477 | 30/7 | .1261 | .1261 | .3783 | .883 | 450 | 296 | 746 | 60.35 | 39.65 | 23800 | .0354 | .0433 | 666 |
| Osprey | 556.5 | 18/1 | .1758 | .1758 | .1758 | .879 | 522 | 82 | 603 | 86.43 | 13.57 | 13700 | .0308 | .0379 | 711 |
| Parakeet | 556.5 | 24/7 | .1523 | .1015 | .3045 | .914 | 524 | 192 | 716 | 73.21 | 26.79 | 19800 | .0307 | .0376 | 721 |
| Dove | 556.5 | 26/7 | .1463 | .1138 | .3413 | .927 | 524 | 241 | 765 | 68.51 | 31.49 | 22600 | .0306 | .0375 | 726 |
| Eagle | 556.5 | 30/7 | .1362 | .1362 | .4086 | .953 | 525 | 345 | 871 | 60.35 | 39.65 | 27800 | .0303 | .0372 | 734 |
| Peacock | 605 | 24/7 | .1588 | .1059 | .3177 | .953 | 570 | 209 | 779 | 73.2 | 26.8 | 21600 | .0282 | .0346 | 760 |
| Squab | 605 | 26/7 | .1525 | .1186 | .3559 | .966 | 570 | 262 | 832 | 68.51 | 31.49 | 24300 | .0281 | .0345 | 765 |
| Wood | 605.0 | 30/7 | .142 | .142 | .426 | .994 | 571 | 375 | 946 | 60.35 | 39.65 | 28900 | .0279 | .0342 | 774 |
| Duck | | | | | | | | | | | | | | | |
| Teal | 605.0 | 30/19 | .142 | .0852 | .426 | .994 | 571 | 367 | 939 | 60.88 | 39.14 | 30000 | .0279 | .0342 | 773 |
| Kingbird | 636 | 18/1 | .188 | .188 | .188 | .94 | 596 | 94 | 690 | 86.43 | 13.57 | 15700 | .0270 | .0332 | 773 |
| Swift | 636.0 | 36/1 | .1329 | .1329 | .1329 | .93 | 596 | 47 | 643 | 92.72 | 7.28 | 13690 | .0271 | .0334 | 769 |
| Rook | 636 | 24/7 | .1628 | .1085 | .3256 | .977 | 599 | 219 | 818 | 73.22 | 26.78 | 22600 | .0268 | .0330 | 784 |
| Grosbeak | 636 | 26/7 | .1564 | .1216 | .3649 | .991 | 599 | 275 | 874 | 68.51 | 31.49 | 25200 | .0267 | .0328 | 789 |
| Scoter | 636.0 | 30/7 | .1456 | .1456 | .4368 | 1.019 | 600 | 395 | 995 | 60.35 | 39.65 | 30400 | .0256 | .0325 | 798 |
| Egret | 636 | 30/19 | .1456 | .0874 | .4368 | 1.019 | 600 | 386 | 987 | 60.85 | 39.15 | 31500 | .0266 | .0326 | 798 |
| Flamingo | 666.6 | 24/7 | .1667 | .1111 | .3333 | 1 | 628 | 230 | 858 | 73.21 | 26.79 | 23700 | .0256 | .0315 | 807 |
| Gannet | 666.6 | 26/7 | .1601 | .1245 | .3736 | 1.014 | 628 | 289 | 916 | 68.51 | 31.49 | 26400 | .0255 | .0313 | 812 |
| Stilt | 715.5 | 24/7 | .1727 | .1151 | .3453 | 1.036 | 674 | 247 | 920 | 73.21 | 26.79 | 25500 | .0239 | .0294 | 844 |
| Starling | 715.5 | 26/7 | .1659 | .129 | .3871 | 1.051 | 674 | 310 | 984 | 68.51 | 31.49 | 28400 | .0238 | .0292 | 849 |
| Redwing | 715.5 | 30/19 | .1544 | .0927 | .4633 | 1.081 | 676 | 435 | 1110 | 60.85 | 39.15 | 34600 | .0236 | .0290 | 859 |
| Coot | 795 | 36/1 | .1486 | .1486 | .1486 | 1.04 | 745 | 58 | 804 | 92.72 | 7.28 | 16710 | .0217 | .0268 | 884 |
| Drake | 795 | 26/7 | .1749 | .136 | .408 | 1.107 | 749 | 344 | 1093 | 68.51 | 31.49 | 31500 | .0214 | .0263 | 907 |
| Tern | 795 | 45/7 | .1329 | .0886 | .2658 | 1.063 | 749 | 146 | 895 | 83.67 | 16.33 | 22100 | .0216 | .0269 | 887 |
| Condor | 795 | 54/7 | .1213 | .1213 | .364 | 1.092 | 749 | 274 | 1023 | 73.21 | 26.79 | 28200 | .0215 | .0272 | 889 |
| Mallard | 795 | 30/19 | .1628 | .0977 | .4884 | 1.14 | 751 | 483 | 1234 | 60.86 | 39.14 | 38400 | .0213 | .0261 | 918 |
| Ruddy | 900 | 45/7 | .1414 | .0943 | .2828 | 1.131 | 848 | 165 | 1013 | 83.67 | 16.33 | 24400 | .0191 | .0239 | 958 |
| Canary | 900 | 54/7 | .1291 | .1291 | .3873 | 1.162 | 848 | 310 | 1158 | 73.22 | 26.78 | 31900 | .0190 | .0241 | 961 |
| Rail | 954 | 45/7 | .1456 | .0971 | .2912 | 1.165 | 899 | 175 | 1074 | 83.67 | 16.33 | 25900 | .0180 | .0225 | 993 |

Although TP conductors are illustrated in the figures, the double V stringing block 100 can accommodate single conductors and twisted pair (TP) conductors. Twisted pair conductors are two single conductors twisted together.

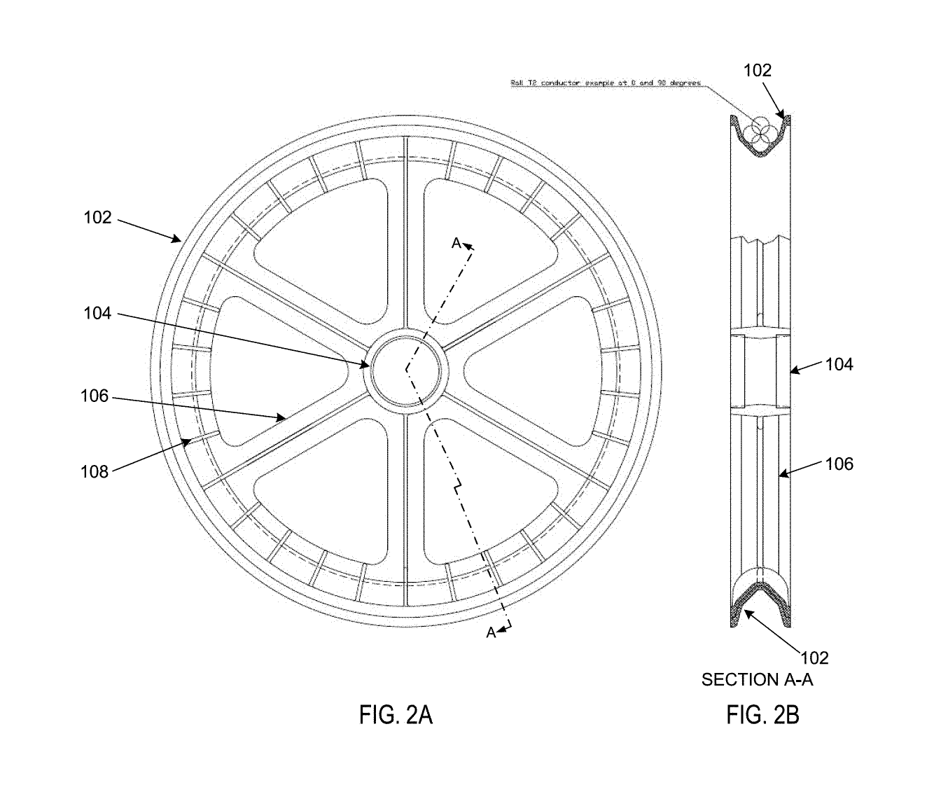

FIG. 2A shows an elevation view of the double V stringing block 100 and FIG. 2B shows a cross-sectional side view of the double V stringing block 100.

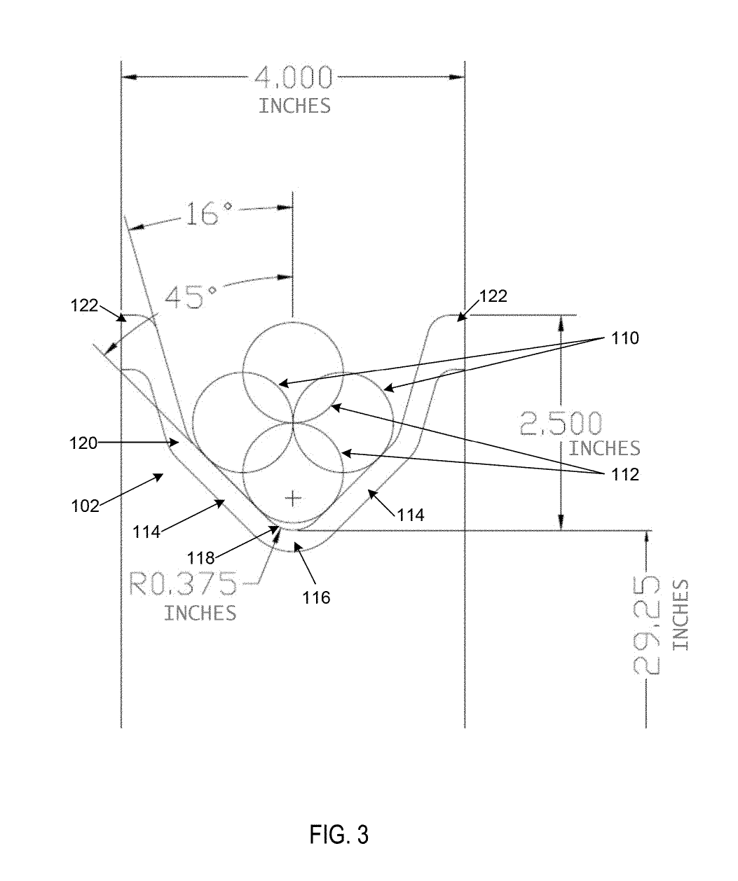

FIG. 3 shows a partial cross-sectional view of the groove 102 in the double V stringing block 100. FIG. 3 shows two sets of TP conductors 110, 112 within groove 102. TP conductor 110 is depicted by the two non-overlapping horizontally adjacent circles in FIG. 3. TP conductor 112 is depicted by the two non-overlapping vertically adjacent circles in FIG. 3. TP conductor 110 is depicted in a 0 degree orientation. TP conductor 112 is depicted in a 90 degree orientation. The orientation of a TP conductor will change as the TP conductor moves through the double V stringing block 100 due to the twisting of the single conductors that make up the TP conductor. Accordingly, one location of a TP conductor may have a first orientation (such as a 0 degree orientation) and a subsequent location of the same TP conductor may have a second orientation (such as a 90 degree orientation) due to the twisting of the TP conductor. The TP conductors 110, 112 are shown simultaneously within groove 102 for illustrative purposes only; the circles in TP conductors 110, 112 represent individual conductors that are solid and, therefore, do not overlap.

FIG. 3 shows that the groove 102 may include a pair of opposed wall surfaces 114 that coverage at a base surface 116. The base surface 116 may include a groove radius 118 that may be configured to hold a single or TP conductor. The groove radius 118 has a radius of about 0.375 inches in FIG. 3.

Each wall 114 of the opposed wall surfaces 114 extends outwardly from a center of the base surface 116 at an angle of approximately 45 degrees from vertical (for a total of an approximately 90 degree sheave angle between the inner surfaces of the opposing walls 114) to a flair point 120. Each wall 114 of the opposed wall surfaces 114 may further extend outwardly from the flair point 120 at an angle of approximately 16 degrees measured from a vertical line bisecting the center of the base surface 116 (for a total of an approximately 32 degree sheave angle between the inner surfaces of the opposing walls 114 beyond the transition or flair point 120). Each of the opposing wall surfaces 114 may end at a rim edge 122. The groove radius 118 of the double V stringing block 100 may be configured so that it does not affect the initial approximately 90 degree sheave angle for all size conductors (single and/or TP).

The approximately 90 degree bottom sheave angle between walls 114 of the double V stringing block 100 may permit the groove 102 to provide nearly the same center of gravity for the TP conductors at the approximately 0 degree and approximately 90 degree orientations. The center of gravity for a section of a TP conductor is located at the intersection of the two circles representing the TP conductor. FIG. 3 shows that the intersection of the two circles in TP conductor 110 is nearly in the same location as the intersection of the two circles in TP conductor 112. Accordingly, TP conductor 110 (which is in a 0 degree orientation) has nearly the same center of gravity as TP conductor 112 (which is in a 90 degree orientation). Maintaining a nearly constant center of gravity throughout a TP conductor as the TP conductor is moved through the double V stringing block 100, despite the changing orientations of the conductors, may minimize vertical movement or vibration of the TP conductor, which may advantageously prevent damage to the TP conductor.

The second sheave angle (flair angle) of approximately 32 degrees may provide a similar, or relatively stable, center of gravity for larger sized TP conductors. Because the flair angle is smaller than the 90 degree bottom sheave angle, the flair angle is able to hold the conductors up and maintain a close center of gravity in relation to the x-axis (horizontal) of the groove 102. The smaller flair angle reduces the width of the groove 102 in the region of the flair angle, relative to the width if the approximately 90 degree first sheave angle continued throughout the groove 102. The relatively smaller width of the groove 102 in the region of the flair angle reduces the distance a conductor can move horizontally within the groove 102 as the conductor is moved through the double V stringing block 100. Reducing the distance a conductor can move horizontally may reduce the force of impact when the conductor contacts the wall 114 of the groove 102, which may advantageously prevent damage to the conductor. Reducing the distance a conductor can move horizontally may also minimize the vibration of the conductor, which may advantageously prevent damage to the conductor.

The double V stringing block 100 may reduce the amplitude of the horizontal and/or vertical vibration of conductors being moved through the groove 102 by up to 50 percent compared to currently-known stringing blocks.

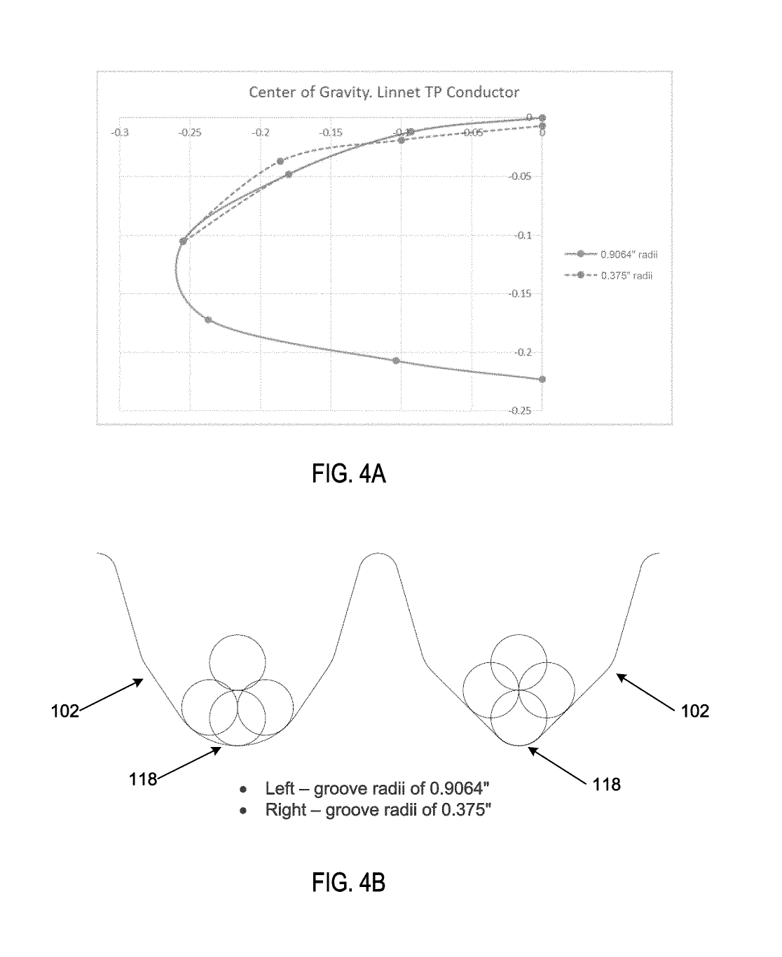

Referring to the groove radius 118, a radius of about 0.375 inches was chosen due to the minimal vibrations compared to a groove radius of approximately 0.9064 inches. FIG. 4A shows a graph of the position of the center of gravity of a Linnet TP conductor as the orientation of the TP conductor changes from a 0 degree orientation to a 90 degree orientation for both a groove radius 118 of 0.375 inches and 0.9064 inches. The axes of the graph in FIG. 4A are x-y coordinates in inches. FIG. 4A shows that the position of the center of gravity with a groove radius 118 of about 0.375 inches is more stable than the position of the center of gravity with a groove radius 118 of approximately 0.9064 inches.

FIG. 4B is an exemplary cross-sectional view of groove 102 with groove radii of 0.375 inches and 0.9064 inches. FIG. 4B shows that the center of gravity (the intersection of the two circles representing the TP conductor) stays in approximately the same position for a 0 degree orientation and a 90 degree orientation when the groove radius is 0.375 inches, whereas the position of the center of gravity moves vertically when the groove radius is 0.9064 inches.

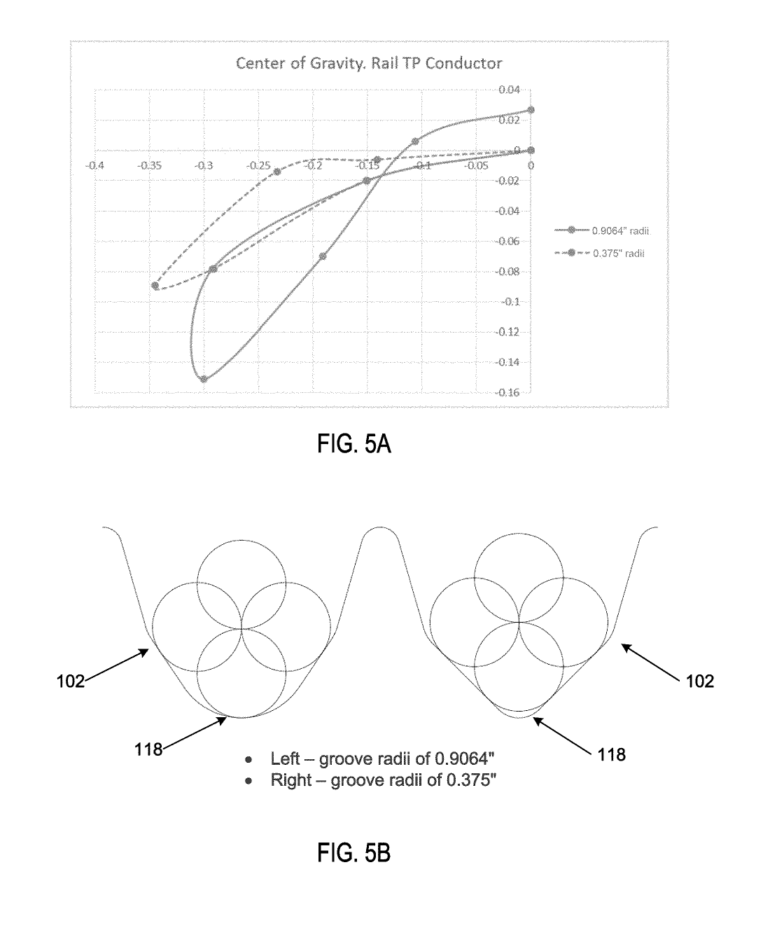

Similar to FIG. 4A, FIG. 5A shows a graph of the position of the center of gravity of a Rail TP conductor as the orientation of the TP conductor changes from a 0 degree orientation to a 90 degree orientation for both a groove radius 118 of about 0.375 inches and approximately 0.9064 inches. FIG. 5A shows that the position of the center of gravity with a groove radius 118 of about 0.375 inches is more stable than the position of the center of gravity with a groove radius 118 of approximately 0.9064 inches. FIG. 5B is an exemplary cross-sectional view of groove 102 with groove radii of 0.375 inches and 0.9064 inches.

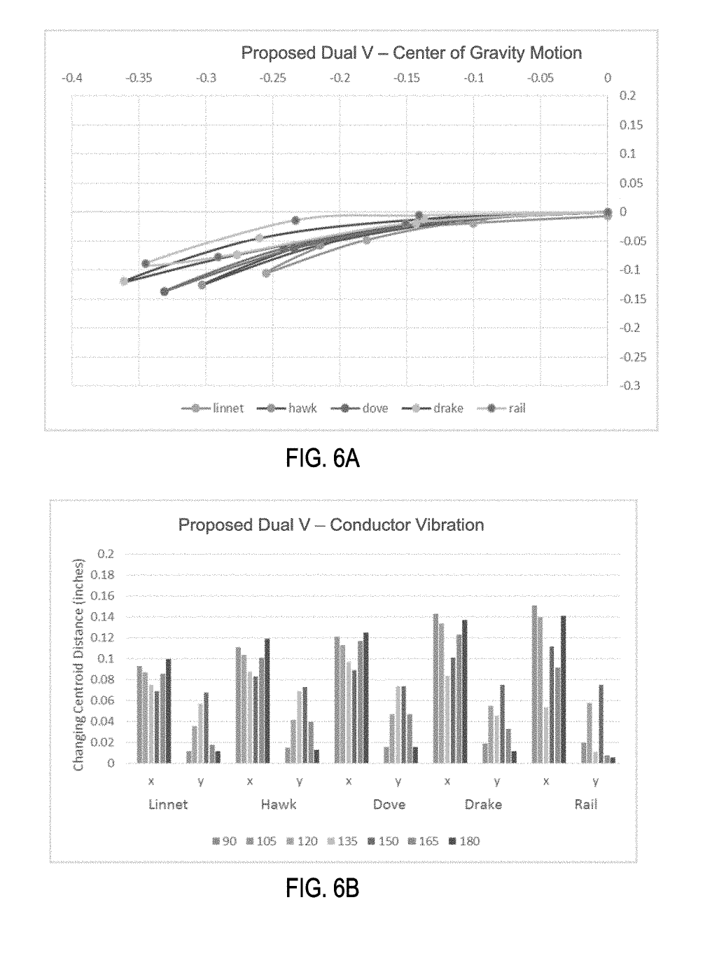

FIG. 6A shows a graph of the position of the center of gravity of several TP conductor sizes (Linnet, Hawk, Dove, Drake, and Rail) as the TP conductor orientation changes from 90 degrees to 180 degrees in the double V stringing block 100. The axes of the graph in FIG. 6A are x-y coordinates in inches.

FIG. 6B shows the displacement in the x and y coordinate directions of the centroids of several TP conductor sizes (Linnet, Hawk, Dove, Drake, and Rail) as the TP conductor orientation changes from 90 degrees to 180 degrees in the double V stringing block 100. FIG. 6B shows that the displacement in the x-direction is less than the displacement in the y-direction.

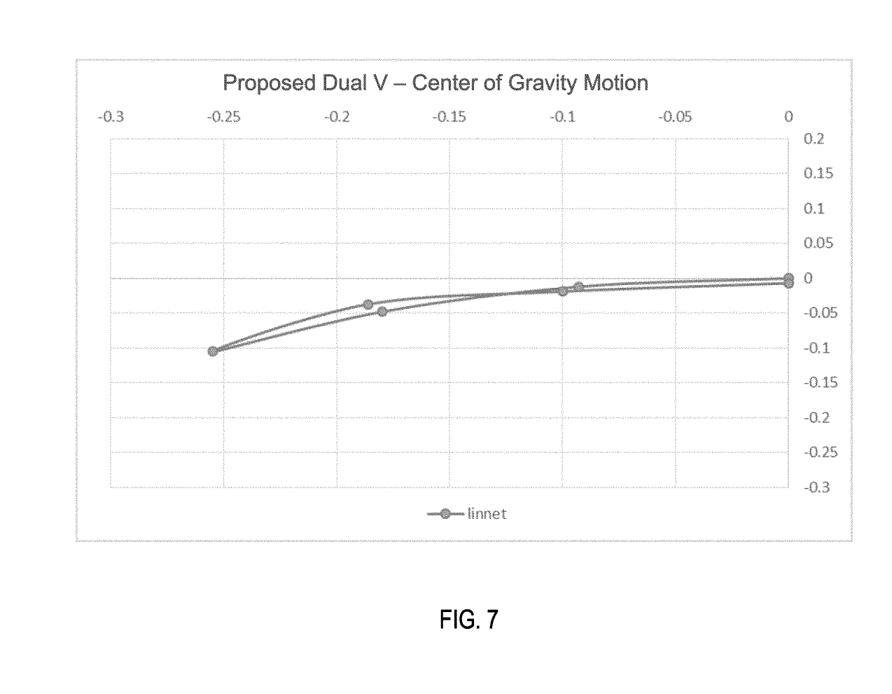

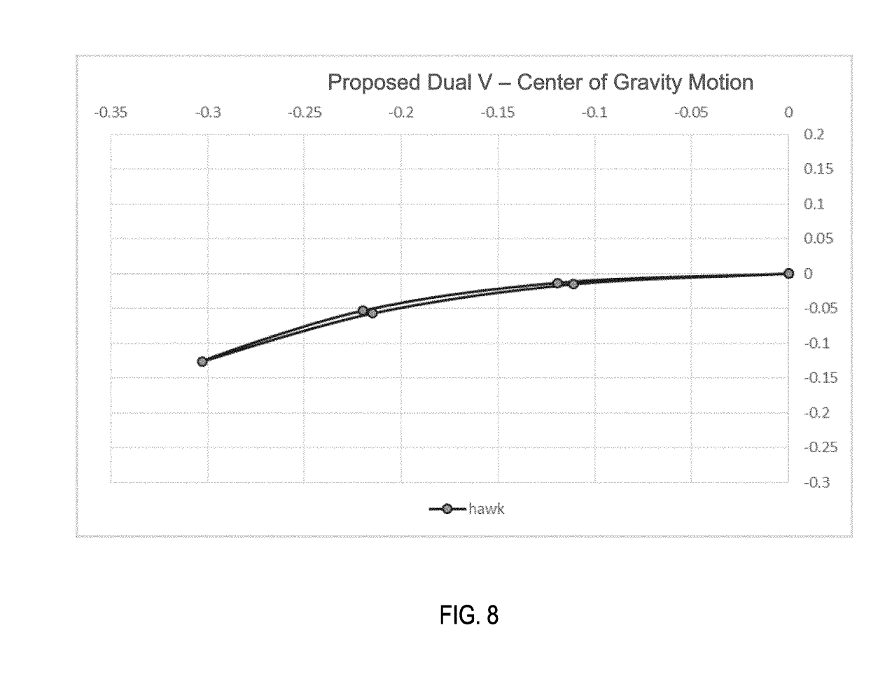

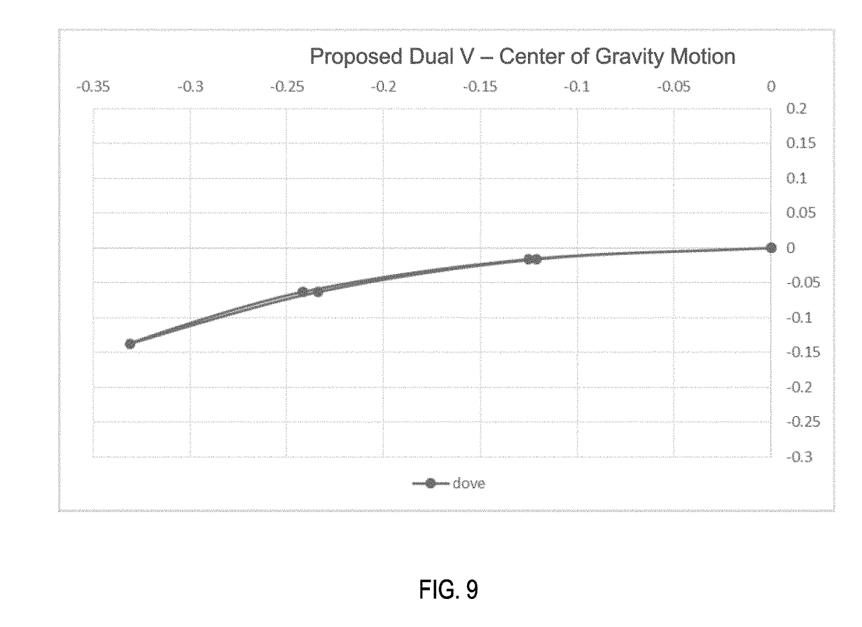

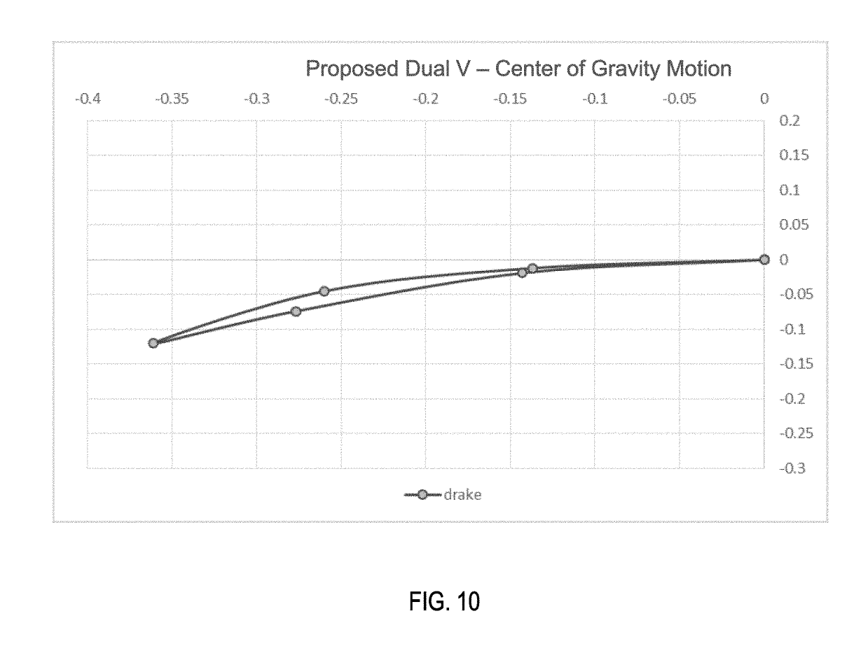

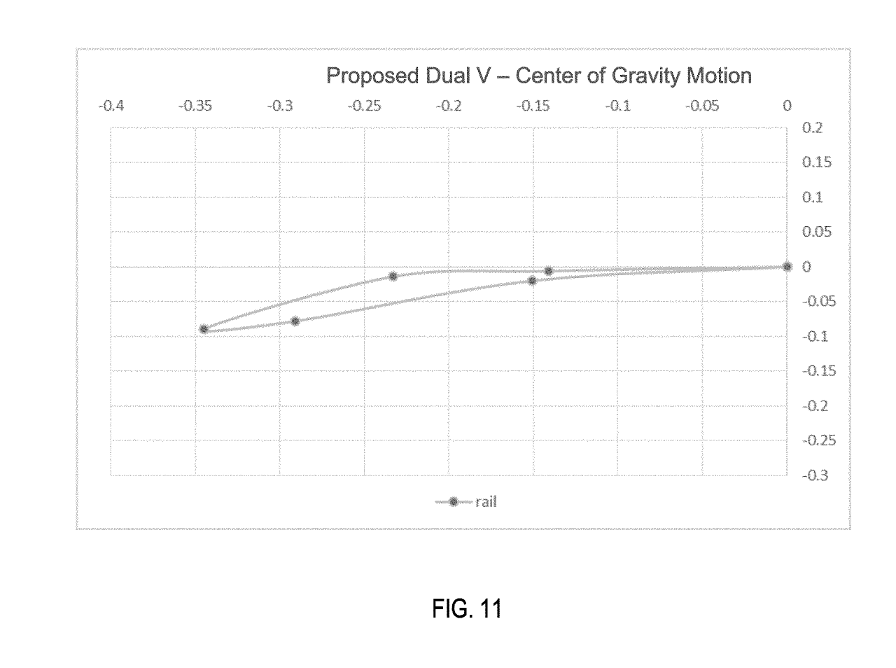

FIGS. 7-11, respectively, show graphs of the positions of the centers of gravity of the TP conductor sizes in FIG. 6A as the TP conductor orientation changes from 90 degrees to 180 degrees in the double V stringing block 100. The axes of the graph in FIGS. 7-11 are x-y coordinates in inches.

In other configurations of the double V stringing block 100, the base groove radius 118 of the groove 102 may have a radius between about 0 inches and about 0.625 inches. In yet another configuration of the double V stringing block 100, each wall of the opposed wall 114 surfaces may extend outwardly from the center of the base surface 116 to the flair point 120 at an angle of between about 40 degrees to about 50 degrees (for a total of an approximately 80 to approximately 100 degrees between the inner surfaces of the opposing walls 114). In yet another configuration of the double V stringing block 100, each wall of the opposed wall surfaces 114 may extend outwardly from the flair point 120 to the rim edge 122 at an angle between about 0 degrees to about 25 degrees measured from a line vertically bisecting the center of the base 116. Each wall of the opposed wall surfaces 114 should flair outward from the flair point 120 to the rim edge 122 at an angle between 12 degrees to 20 degrees from the vertical line to facilitate passage of swivels, grips, etc. and to contain the electrical conductor within the groove, particularly at line angles. In some configurations of the double V stringing block 100 the angle of the opposing walls 114 may be a combination of one or more of the ranges described above.

The minimum groove radius 118 should be about 1.10 times the radius of the electrical conductor used in the groove 102. Sheaves with a groove radius 118 may, with limitations, be used with smaller electrical conductors. The limitations may relate to the number of layers of aluminum wires in the electrical conductors. The more layers of aluminum wires, the more important it is to support the electrical conductor with a well-fitting groove. The depth of the groove 102 should be a minimum of 25 percent greater than the diameter of the electrical conductor.

The double V stringing block 100 allows for the use of multiple sizes of single and TP electrical conductors. The double V stringing block 100 may be used by utility companies to simplify many facets of a lineman's job. Accordingly, the use of the double V stringing block 100 may lead to making the dangerous job of a lineman safer over time due to repetition of using the same stringing block, as opposed to requiring the lineman to use many different stringing blocks.

It should be understood that the stringing blocks disclosed are not limited to the configurations described, modifications may be made without departing from the disclosures herein. While the configurations described herein may refer to certain features, it should be recognized that the features described herein are interchangeable and may be included or excluded as necessary, unless described otherwise, even where no reference is made to a specific feature. It should also be understood that the advantages described above are not necessarily the only advantages of the stringing blocks, and it is not necessarily expected that all of the described advantages will be achieved with every feature of the disclosed configurations. The scope of the disclosure is defined by the appended claims, and all devices and methods that come within the meaning of the claims, either literally or by equivalence, are intended to be embraced therein.

A sheave comprising:

1. a circumferential groove, the circumferential groove including a pair of opposed wall surfaces that converge at a base surface, where each of the opposed wall surfaces extends outwardly from the base surface to a flair point at an angle of approximately 45 degrees with respect to a vertical line bisecting the center of the base surface, and where each of the opposed wall surfaces extends outwardly from the flair point at an angle of approximately 16 degrees with respect to the vertical line to a rim.

2. The sheave of claim 1, where the base surface comprises a groove radius of approximately 0.375 inches.

3. The sheave of claim 1, where the circumferential groove is configured to hold a twisted pair of electrical conductors at an approximately 0 degree orientation and at an approximately 90 degree orientation.

4. The sheave of claim 3, where the center of gravity of the portion of the twisted pair of electrical conductors held in the circumferential groove remains in approximately the same location in the approximately 0 degree and approximately 90 degree orientations.

5. The sheave of claim 1, where the circumferential groove is configured such that a twisted pair of electrical conductors held in the circumferential groove can rotate up to 360 degrees.

6. The sheave of claim 1, further comprising rim edges on the pair of opposed wall surfaces, where the rim edges extend away from the vertical line bisecting the center of the base surface.

7. The sheave of claim 1, where the sheave is circular.

8. The sheave of claim 1, where the sheave is not circular.

9. The sheave of claim 1, where the circumferential groove is integrally formed in the sheave.

10. The sheave of claim 1, where the circumferential groove is not integrally formed in the sheave.

11. The sheave of claim 10, where the circumferential groove includes urethane material attached to a portion of the sheave.

12. The sheave of claim 1, where the circumferential groove is configured to hold a twisted pair of electrical conductors where the individual electrical conductors have outside diameters of approximately 1.165 inches.

13. The sheave of claim 1, where the base surface comprises a groove radius that is less than 1.1 times a radius of an electrical conductor that the circumferential groove is configured to hold.

14. The sheave of claim 1, where a depth of the circumferential groove is 25 percent larger than a diameter of an electrical conductor that the circumferential groove is configured to hold.

15. The sheave of claim 1, where a centroid of an electrical conductor within the circumferential groove moves more in a horizontal direction than in a vertical direction when the orientation of the electrical conductor changes from 90 degrees to 180 degrees.

16. The sheave of claim 1, where the flair point is located at an approximate midpoint of the opposed wall surfaces.

17. The sheave of claim 1, further comprising a central hub and a plurality of spokes, where the plurality of spokes attach the circumferential groove to the central hub.

18. The sheave of claim 17, further comprising a plurality of ribs, where the plurality of ribs extend away from the base surface in a direction opposite the pair of opposed wall surfaces.

19. A sheave comprising:
a groove extending along an outer circumference of the sheave, the groove including a first wall surface and an opposing second wall surface;
the first wall surface having a first bottom portion and a first top portion converging at a first transition point; and
the second wall surface having a second bottom portion and a second top portion converging at a second transition point,
where the first bottom portion is oriented at an angle of approximately 90 degrees with respect to the second bottom portion, and
where the first top portion is oriented at an angle of approximately 32 degrees with respect to the second top portion.

20. A stringing block assembly comprising:
a frame; and
a sheave rotatably mounted in the frame, where the sheave comprises:
a circumferential groove, the circumferential groove including a pair of opposed wall surfaces that converge at a base surface, where each of the opposed wall surfaces extends outwardly from the base surface to a flair point at an angle of approximately 45 degrees with respect to a vertical line bisecting the center of the base surface, and where each of the opposed wall surfaces extends outwardly from the flair point at an angle of approximately 16 degrees with respect to the vertical line to a rim.
